(19) United States
(12) Patent Application Publication
(10) Pub. No.: US 2003/0130857 A1
(43) Pub. Date: Jul. 10, 2003

(54) Systems, methods and computer program products for utilizing an information exchange framework

(76) Inventor: Masanobu Matsuo, Rancho Palos Verdes, CA (US)

Correspondence Address: David B. Abel, Esq., Squire, Sanders & Dempsey L.L.P., 14th Fl., 801 S. Figueroa St., Los Angeles, CA, 90017-5554, US

(21) Appl. No.: 10/040,011

(22) Filed: Jan. 4, 2002

(51) Int. Cl. G06F 17/60

(52) U.S. Cl. 705/1

(57) ABSTRACT

Systems, methods and computer program products for utilizing an information exchange framework are disclosed. In a first embodiment, a memo may be exchanged between invitees to a meeting utilizing the information exchange framework. In a second embodiment, security information may be exchanged between a shopper and a store utilizing the information exchange framework. In a third embodiment, the information exchange framework may be utilized as a forwarding intermediary during the exchange of email communications between parties.

### FIELD OF THE INVENTION

This invention relates to information exchange, and more particularly, relates to network facilitated exchanges of information.

### BACKGROUND OF THE INVENTION

Frequently, when two business people meet, they typically exchange business cards with one another as a means to exchange limited personal and business profile information about each of the parties. The information presented on these business cards may be a very important business asset and this information is often stored in a hard copy format or input into an electronic contact list. However, in either case, the information obtained from traditional business cards cannot be updated dynamically and, as a result, do not automatically update themselves as a person changes positions or jobs, etc. Thus, with traditional business cards, a holder of a business card can never be sure that all the information displayed on the collected business cards is current and up to date.

### SUMMARY OF THE INVENTION

Systems, methods and computer program products for utilizing an information exchange framework are disclosed.

In a first embodiment, a system, method and computer program product are disclosed for exchanging a memo in an information exchange framework. In this embodiment, a database is maintained having information about a plurality of users. The information about each user includes a public identifier associated with the particular user. A request is received via a network to facilitate a meeting. The request includes a memo for presentation at the meeting and an invitation list of public identifiers of users to be invited to the meeting. The memo and the list of public identifiers are stored in the database. Information about each user to be invited to the meeting is retrieved from the database utilizing the public identifiers of the invitation list. The retrieved information about each user includes information about a network address for contacting the user. In response to the request, a meeting identifier is generated that includes a link to the memo stored in the database. The meeting identifier is then transmitted via the network to the network addresses of the users invited to the meeting. Subsequently, the meeting identifier is received from at least one of the users invited to the meeting via the network. Those users from which the meeting identifier has been received are then permitted to access the memo in the database via the network.

In one aspect of this embodiment, at least one of the users may receive the meeting identifier using a wireless device in communication with the network. In another aspect of this embodiment, the meeting identifier may comprise a numeric character string and/or an alphanumeric character string. In a further aspect of this embodiment, the network may be capable of communicating utilizing at least one of TCP/IP and IPX protocols.

In a second embodiment, a system, method and computer program product are disclosed for exchanging security information in an information exchange framework. In this embodiment, a unique security identifier is associated with a user. The security identifier is stored in a database that also includes information about the user that identifies the user and an account balance associated with the user. Subsequently, the security identifier of the user is received via the network from a third party that obtained the security identifier from a customer involved in a commercial transaction with the third party. The information about the user is transmitted from the database to the third party via the network to permit the third party compare the received information about the user with information obtained from the customer. Next, an indication is received via the network from the third party that indicates whether information obtained from the customer matches the received information about the user. The third party is permitted to adjust the balance of the account of the user via the network as part of completion of the commercial transaction if the indication indicates that the information obtained from the customer matches the received information about the user.

In one aspect of this embodiment, the information about the user transmitted from the database may be encrypted. In another aspect of this embodiment, the security identifier may comprise at a numeric character string and/or an alphanumeric character string. In a further aspect of this embodiment, the network may be capable of communicating utilizing TCP/IP and/or IPX protocols.

In a third embodiment, a system, method and computer program product are disclosed for exchanging email communication utilizing an information exchange framework. In this embodiment, an intermediary email address is created for a user to which an email message addressed to the intermediary email address may be transmitted via a network. Information about one or more authorized parties associated with the user is received via the network. The information about one or more authorized parties includes an email address associated with each the one or more authorized parties. The information relating to the intermediary email address and the information about the one or more third parties are stored in a database. The database also contains additional information about the user including a forwarding email address of the user. An email addressed to the intermediary email address of the user is subsequently received via the network. The received email has a sender email address which identifies the email address of the sender. The sender email address is compared with email addresses of the authorized parties associated with the user stored in the database. If the sender email address is determined to match one of the email addresses of the authorized parties associated with the user stored in the database, then the received email is forwarded via the network to the forwarding email address of the user.

In one aspect of this embodiment, a record of each received email addressed to the intermediary email address of the user may be stored in a log in the database. In such an aspect, the user may be permitted to access the log via the network to review the record stored therein. As a further option, the user may access the log utilizing a wireless device in communication with the network.

### BRIEF DESCRIPTION OF THE DRAWINGS

FIG. 1 is a schematic block diagram of a personal information exchange framework 100 in accordance with an embodiment of the invention;

FIG. 2 is a flowchart of a process for registering with a personal information exchange framework in accordance with an embodiment of the invention;

FIG. 3 is a flowchart of a process for setting access rights to personal information in a personal information exchange framework in accordance with an embodiment of the invention;

FIG. 4 is a flowchart of a process for obtaining personal information in a personal information exchange framework in accordance with an embodiment of the invention;

FIG. 5 is a flowchart of a process for logging access to personal information about a subject in a personal information exchange framework in accordance with an embodiment of the invention;

FIG. 6 is a flowchart of a process for updating information in a personal information exchange framework in accordance with an embodiment of the invention;

FIG. 7 is a flowchart of a process for maintaining a contact list in a personal information exchange framework in accordance with an embodiment of the invention;

FIG. 8 is a flowchart of a process for exchanging a memo in a personal information exchange framework in accordance with an embodiment of the invention;

FIG. 9 is a flowchart of a process for exchanging security information in a personal information exchange framework in accordance with an embodiment of the invention;

FIG. 10 is a flowchart of a process for exchanging email communication utilizing a personal information exchange framework in accordance with an embodiment of the invention;

FIG. 11 is a schematic diagram of an illustrative network system with a plurality of components in accordance with an embodiment of the present invention; and

FIG. 12 is a schematic diagram of a representative hardware environment in accordance with an embodiment of the present invention.

### DETAILED DESCRIPTION

Embodiments of the present invention provide for a personal information exchange framework which helps to facilitate the exchange process of information and automatic updating of the exchanged information.

For purposes of aiding comprehension of embodiments of the invention, a business card (BC) may be defined as a card format in which individual profile information may be displayed with a subject's identity as a key. The identity of a subject may be the name of individual person, employee number, social security number, or any unique identifier that identifies the user/subject.

The BC may be a physical card or in an electric format. In embodiments of the invention, a BC may be represented as a certain electronic form of data which can be accessed by computers, browsers and other data processing devices.

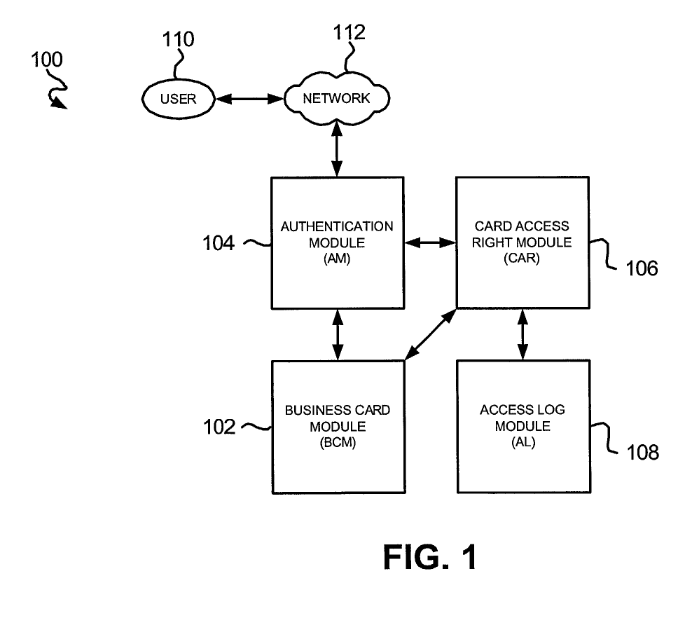

FIG. 1 is a schematic block diagram of a personal information exchange framework 100 in accordance with an embodiment of the invention. As depicted in FIG. 1, the personal information exchange framework may include a business card module 102, an authentication module 104, a card access right module 106, and an access log module 108. The modules of the personal information exchange framework may all reside in a common host (e.g., a computer) or in a distributed environment (e.g., more than one computer) where some or all of the modules are connected together by a network. In one embodiment, a user 110 may interface and access the personal information exchange framework via a network 112.

A function of business card module is to store and manage BC related information. The BC related information may be stored in a central database or in a distributed database. A BC may also be stored in a networked device. Thus, the business card module (BCM) 102 may be utilized to store and controls a subject's BC's. For each BC, the subject/owner's identity, registered data and timestamp, and profile information may be stored as a unit. In one embodiment, information stored in the business card module may have version information attached so that any change of a BC may be recorded and any version may be recovered if needed. A single user may have multiple and different BC's. Conversely, a single BC may have multiple different versions of itself.

The authentication module (AM) 104 may be utilized to register new users of the personal information exchange framework 100, generate private identifiers (PrivateID's) and public identifiers (PublicID's) for the users, and authenticate the identity of users of the personal information exchange framework 100. In one embodiment, in order to access to a BC, it may be required to go through an authentication process performed by the authentication module 104. Such an authentication process may also involve the use of encryption methods such as, for example, a public key infrastructure.

In one embodiment, registration of a user may involve the collection of registration information from the user. Some illustrative examples of registration information includes an identity(ex. name), a telephone number, an address where the user currently lives, an address where the user was born, and other information which may be used to identify a user upon accessing the personal information exchange framework.

A PrivateID is generated by AM and, in one embodiment, is primarily intended to be known only to the registered person (or other authorized persons/entities). A PrivateID may be utilized in the authentication process carried out by the authentication module.

A PublicID may also be generated by the authentication module. A PublicID may be used for exchanging BC's. In one embodiment, a PublicID is in a human-readable and preferably easily memorized. A single user may have multiple PublicID's. Each PublicID may have the following attributes are attached: owner name, owner birthday, owner blood type, owner dependent profile.

The card access right module (CAR) 106 may manages each access right associated with a BC exchange transaction. An access right (AR) may be defined as a structured hierarchy of access rights which specify who has a right to a BC, what comprises the BC, and when such a right to the BC is valid. In particular, an access right specifies a certain BC (i.e., which version of the BC). Such a specification may be done as a predicate expression based on information included in the BC. An access right defines who has a right to a BC by specifies a set of PublicID's which have a right to the particular BC. In one embodiment, an access right may specifies a predicate expression based on attributes of the PublicID. An access right may also define when a right to the BC is valid by specifying a starting time and ending time for the right.

The card access right module may maintain access rights in a hierarchy of access rights which specify who owns a BC, what BC can be exchanged or accessed, when access right is valid, and who has a right to access to the BC. In general, exchanges of information in the personal information exchange framework may be called a card access right (CAR) transaction. A card exchange transaction may be considered as a CAR transaction. CAR's may be given and received utilizing a wireless device such as a cellular phone. A nomenclature of CAR transactions may be illustrated as follows: giving a BC to person A means that a CAR is given to A, while receiving a BC from a person A means a user is receiving a CAR from person A.

An example of a CAR transaction is as follows: Alice exchanges a BC with Bob. Alice can then use her cellular phone to input Bob's PublicID through the authentication module into the card access right module. The CAR then records pre-defined access right, time, and valid period. The CAR may also have a function which can allow a user to select a set of BC's to which a particular recipient may have rights to access. By using a PrivateID, a user may be able change an access right associated with a particular PublicID at any time. BC exchange transactions may also be recorded into the CAR to keep a record of when and whom a user met for retrieval by the user from the CAR at any time.

The access log module (AL) 108 may be utilized to record all histories of who has accessed each BC. The AL may also allow the tracking of when and who accessed the BC of a particular individual. This information may be stored in a central database or in a distributed database.

BC management may be accomplished as follows: after the AM process is completed, a user may create a new BC or updates old BC's. By using the version control function, all versions of BC can be shown upon request by the user. Additionally, a user may also access the personal information exchange framework to retrieve or select BC's which were exchanged by the user. Also, a user can select and/or create a BC-list (i.e., set of BC's), and search any BC which he/she has access right to. With the BCM and the CAR, the BC's of people allowing the access right to the user can then be viewed by the user. Additionally, as long as the access right is valid to that particular version of the BC, the user may be able to search older versions of the BC's stored in the database. A user may also be able to retrieve the access history of the user's own BC's so that the user may investigate who has accessed his or her BC and help monitor accesses from unknown parties and help mainlined the user's privacy of BC information.

The following portions sets forth various implementations of the personal information exchange in accordance with embodiments of the invention.

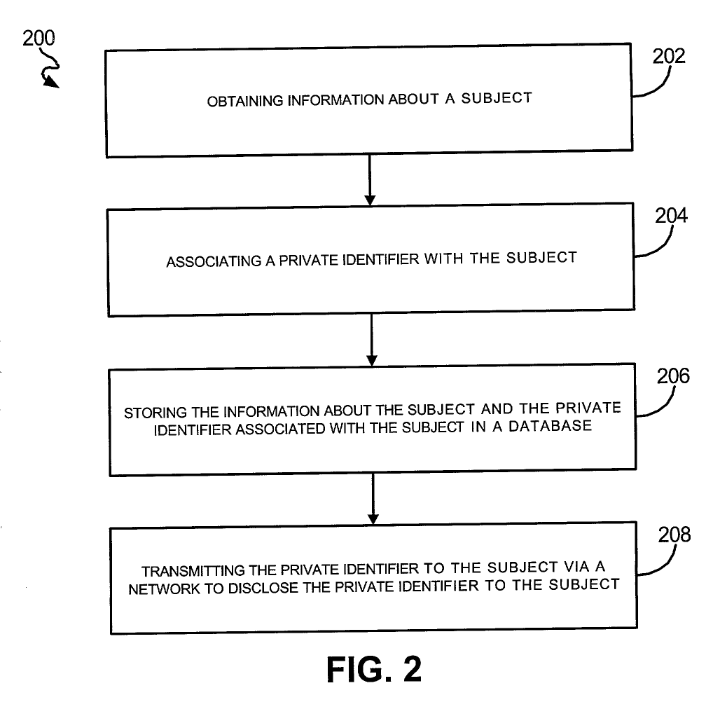

FIG. 2 is a flowchart of a process 200 for registering with a personal information exchange framework in accordance with an embodiment of the invention. In operation 202, personal information about a subject (i.e., a user or subscriber, whether an individual or entity such as, for example a business or organization) is obtained. A private identifier is generated and associated with the subject in operation 204. The personal information about the subject and the private identifier associated with the subject are stored in a database in operation 206. In operation 208, the private identifier is transmitted to the subject via a network to disclose the private identifier to the subject.

In an embodiment of the invention, the personal information about the subject may include at least one of: a name associated with the subject (e.g., a personal name, title, nickname, alias, former name(s), mother's maiden name, and/or business name), an address associated with the subject (e.g., a current residence address, a mailing address, a current business address, a current workplace address, an address where the subject was born, a postal address such as, for example a post office (P.O.) box, and/or another address where mail addressed to the subject can be sent), a telephone number associated with the subject (e.g., a business or work telephone number, a home or residence telephone number, a mobile phone telephone number, a fax number, and/or another telephone number(s) where the subject can be reached or messages for the subject can be left such as, for example, a telephone number to a messaging service), physical feature information about the subject (e.g., sex, height, weight, hair color, eye color), significant calendar dates associated with the subject (e.g., date of birth, current employment start date), employment information about the subject (e.g., employee number), government information associated with the subject (e.g., a social security number, a driver's license number, a passport number, and/or identity card number), and health and physical information about the subject (e.g., height, weight, eye color, hair color, blood type, allergies and/or past and existing medical conditions of the subject), financial account numbers of the subject, additional contact information of the subject, and/or additional data about the subject such as, for example, image data of a signature and/or the face of the subject.

In another embodiment of the invention, at least a portion of the personal information about the subject may be obtained from the subject and/or by utilizing the network. In a further embodiment of the invention, the subject may be permitted to update the personal information about the subject via the network. In yet another embodiment of the invention, the subject may receive the private identifier using a wireless device in communication with the network. Some illustrative examples of suitable wireless devices include, for example, a wireless phone, personal digital assistant (PDA) and/or a computer with wireless communication network interface. In even another embodiment of the invention, the private identifier may comprise a numeric character string and/or an alphanumeric character string. In one embodiment of the invention, the network may comprise the Internet and/or be capable of communicating utilizing of TCP/IP and/or IPX protocols.

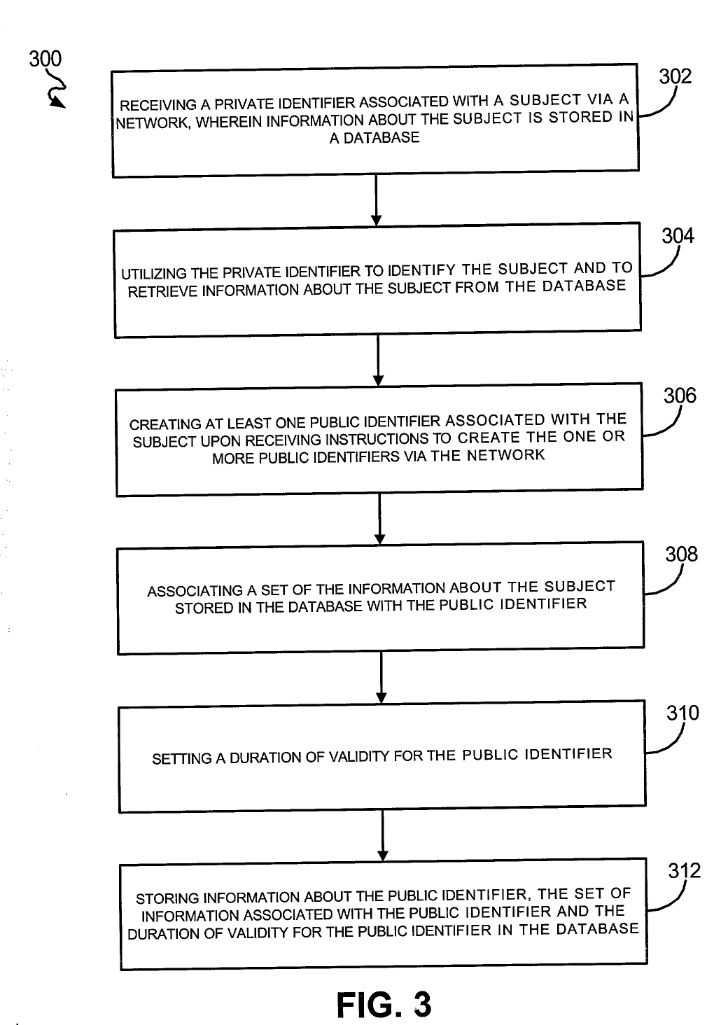

FIG. 3 is a flowchart of a process 300 for setting access rights to personal information in a personal information exchange framework in accordance with an embodiment of the invention. A private identifier associated with a subject is received from a user via a network in operation 302. The user may be, for example, the subject or an authorized party with the private identifier. Additionally, personal information about the subject is stored in a database. In operation 304, the private identifier is utilized to identify the subject and to retrieve personal information about the subject from the database so that access rights to the personal information about the subject may be assigned, the access rights defining conditions for permitting disclosure of the all some or none of personal information about the subject to a third party. At least one public identifier associated with the subject is created in operation 306 upon receiving instructions from the user to create the one or more public identifiers via the network. For each public identifier that is created, the user is permitted to associate a set of the personal information about the subject stored in the database (see operation 308). Also, the user is permitted to set a duration of validity for each public identifier in operation 310. Information about the public identifier, the set of information associated with the public identifier and the duration of validity for the public identifier is then stored in the database in operation 312.

In an embodiment of the invention, the private identifier may be received from a wireless device in communication with the network. In another embodiment of the invention, the information about the subject may include: a name associated with the subject, an address associated with the subject, a telephone number associated with the subject, physical feature information about the subject, one or more significant calendar dates associated with the subject, employment information about the subject, government information associated with the subject, and/or health and physical information about the subject. In a further embodiment of the invention, the private identifier may comprise a numeric character string and/or an alphanumeric character string. In yet another embodiment of the invention, the public identifier may include information about the subject relating to: a name, a date of birth, and/or a blood type. In even another embodiment of the invention, the information about the subject stored in the database may initially be obtained via the network. In an additional embodiment of the invention, the subject may be permitted to update the information about the subject via the network utilizing the private identifier. In such an embodiment, a record may also generated and stored in a log in the database each instance the subject utilizes the private identifier to update the information about the subject.

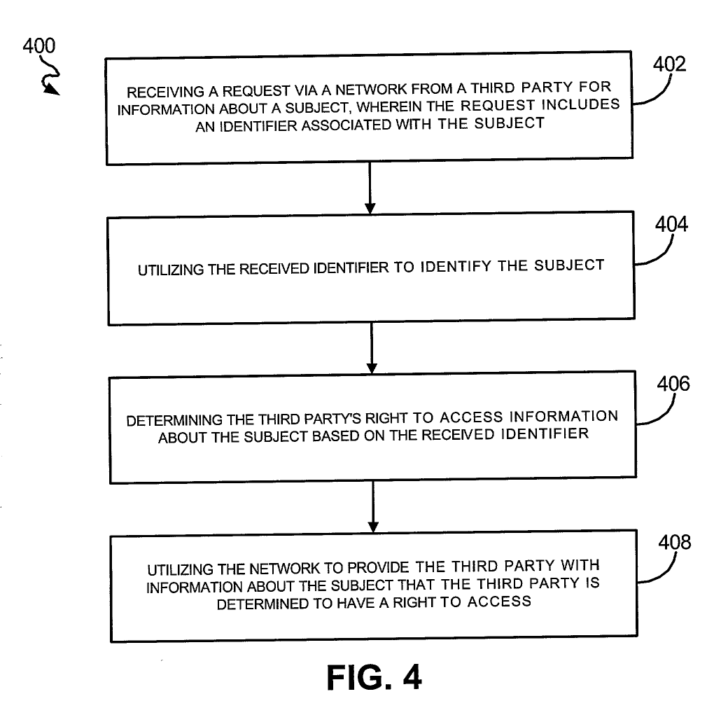

FIG. 4 is a flowchart of a process 400 for obtaining personal information in a personal information exchange framework in accordance with an embodiment of the invention. In operation 402, a request is received via a network from a third party for personal information about a subject. The request includes a public identifier associated with the subject. The received public identifier is then utilized to identify the subject in operation 404 and based on the received identifier, the third party's right to access personal information about the subject is determined in operation 406. The network is then utilized to provide the third party with information about the subject that the third party is determined to have a right to access in operation 408.

In an embodiment of the present invention, the third party may transmit the request via the network utilizing a wireless device. In another embodiment of the present invention, the identifier may comprise a numeric character string and/or an alphanumeric character string. In one embodiment of the present invention, the network may comprise the Internet. In a further embodiment of the present invention, the public identifier may include information about the subject relating t: a name, a date of birth, and/or a blood type of the subject.

In even another embodiment of present invention, the public identifier may have a duration of validity for associated therewith. In such an embodiment, the determination of the third party's right to access personal information about the subject based on the received public identifier may require a determination of whether the request is received within a time frame set by the duration of validity. In an additional embodiment of the present invention, a set of the personal information about the subject stored in the database may be associated with the public identifier. In such an embodiment, determination of the third party's right to access information about the subject based on the received public identifier may require an identification of the set of information stored in the database that is associated received public identifier.

In yet another embodiment of the present invention, information about the third party may also be stored in the database for subsequent retrieval by the subject. In even yet another embodiment of the present invention, the subject may be permitted to update the personal information about the subject via the network.

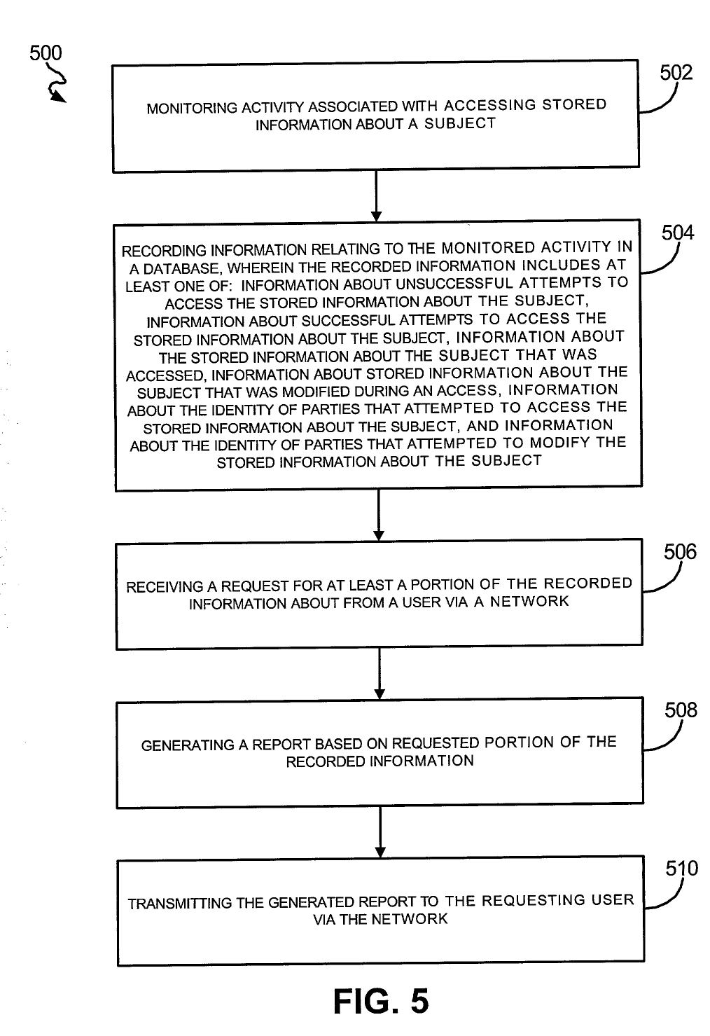

FIG. 5 is a flowchart of a process 500 for logging access to personal information about a subject in a personal information exchange framework in accordance with an embodiment of the invention. In operation 502, activity associated with accessing stored personal information about a subject in a personal information exchange framework is monitored. Information relating to the monitored activity is recorded in a database in operation 504. The recorded information may include: information about unsuccessful attempts to access the stored personal information about the subject, information about successful attempts to access the stored personal information about the subject, information about the stored personal information about the subject that was accessed, information about any stored personal information about the subject that was modified during an access, information about the identity of parties that attempted to (whether successful or unsuccessful) access the stored personal information about the subject, and/or information about the identity of parties that attempted to modify (whether successful or unsuccessful) the stored personal information about the subject.

In operation 506, a request or query is received for at least a portion of the recorded information about from a user via a network. A report is generated based on requested portion of the recorded information in response to the request in operation 508. The report may provide a summary or complete details regarding the requested portion of the recorded information. The generated report is then transmitted to the requesting user in operation 510 via the network.

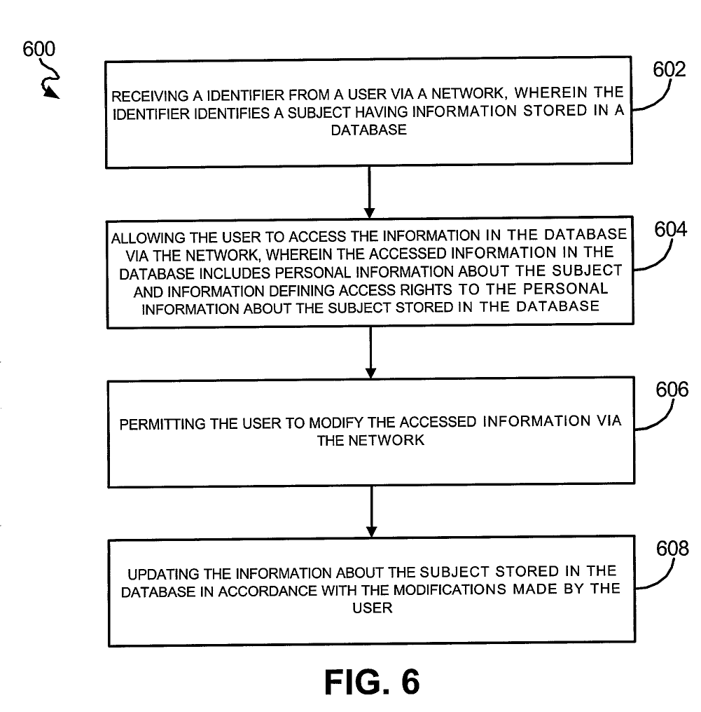

FIG. 6 is a flowchart of a process 600 for updating information in a personal information exchange framework in accordance with an embodiment of the invention. A private identifier is received from a user via a network in operation 602. The private identifier uniquely identifies a subject having information stored in a personal information exchange database. The user is allowed to access the information in the database via the network in operation 604. The accessed information in the database may include personal information about the subject and information relating to and defining one or more access rights to the personal information about the subject stored in the database. The user is permitted to modify the accessed information via the network in operation 606. The information about the subject stored in the database is then updated in accordance with the modifications made by the user in operation 608.

As an illustrative application of the personal information exchange framework, a BC list (e.g., a contacts list) may be created and then shared and updated amongst uses of the personal information exchange framework. Sharing of an individual BC list may be accomplished by each user transferring their existing BC list into the business card module. The business card module may then execute searches and comparisons to find and/or match a particular user's BC in other users' stored BC lists. Once a match is identified, this information may be utilized to broadcast updates to a particular user's BC to everyone in the personal information exchange framework that has that user's BC included in their BC list.

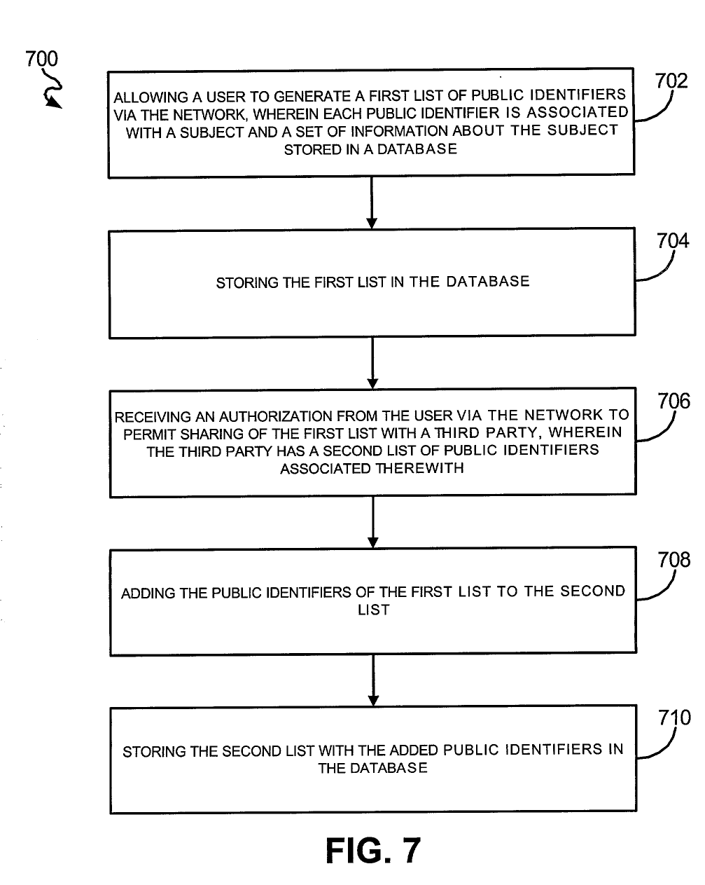

FIG. 7 is a flowchart of a process 700 for maintaining a contact list in a personal information exchange framework in accordance with an embodiment of the invention. In operation 702, a user is allowed to generate a first list of public identifiers via the network. Each public identifier is associated with a subject and a set of personal information about the subject stored in a database. In operation 704, the first list of public identifiers is stored in the database. An authorization is received from the user in operation 706 via the network to permit sharing of the first list of the public identifiers with a third party that has a second list of public identifiers associated therewith. In operation 708, the public identifiers of the first list are added to the second list and the second list with the added public identifiers is stored in the database in operation 710.

As another illustrative application of the personal information exchange framework, a meeting memo may be generated and issued to users of the personal information exchange framework. For example, a meeting ID to people for attending a meeting may be issued via, for example, a wireless phone access to the personal information exchange framework. The personal information exchange framework then transmits e-mail messages that include the meeting ID to the invitees. With the meeting ID, invitees may indicate their intentions to attend the meeting and, also, access information stored in the personal information exchange framework associated with the meeting such as, for example, a memo or agenda of the meeting stored in the personal information exchange framework.

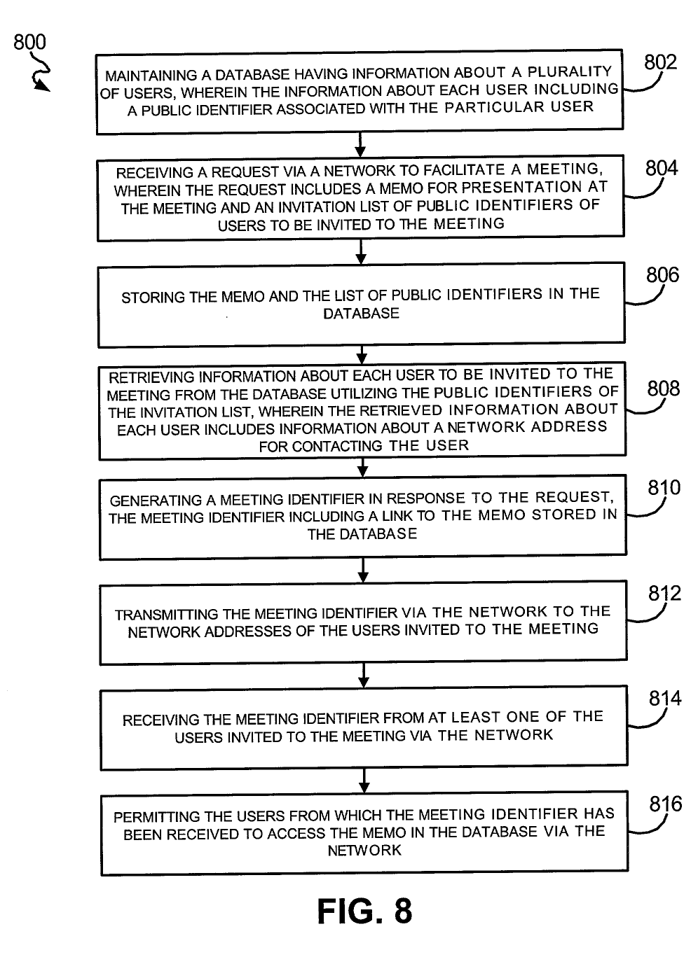

FIG. 8 is a flowchart of a process 800 for exchanging a memo in a personal information exchange framework in accordance with an embodiment of the invention. In operation 802, a database is maintained having information about a plurality of users. The information about each user includes a public identifier associated with the particular user. A request is received via a network to facilitate a meeting in operation 804. The request includes a memo for presentation at the meeting and an invitation list of public identifiers of users to be invited to the meeting. The memo and the list of public identifiers are stored in the database in operation 806. Information about each user to be invited to the meeting is retrieved from the database utilizing the public identifiers of the invitation list in operation 808. The retrieved information about each user includes information about a network address for contacting the particular user. In response to the request, a meeting identifier is generated in operation 810 that includes a link to the memo stored in the database. The meeting identifier is then transmitted via the network to the network addresses of the users invited to the meeting in operation 812. In operation 814, the meeting identifier is received from at least one of the users invited to the meeting via the network. Those users from which the meeting identifier has been received are then permitted to access the memo in the database via the network in operation 816.

In one aspect of this embodiment, at least one of the users may receive the meeting identifier using a wireless device in communication with the network. In another aspect of this embodiment, the meeting identifier may comprise a numeric character string and/or an alphanumeric character string. In a further aspect of this embodiment, the network may be capable of communicating utilizing at least one of TCP/IP and IPX protocols.

As a further illustrative application, the personal information exchange may be utilized to facilitate an e-point method for shopping: In such an application, the personal information exchange process may extend to e-point method for shops. A shopper (as a user of the framework) can access the BC authentication process in the framework and get a security-code (e.g., a private identifier) before shopping. When the shopper is in a shop, the security-code can be given to the shop. The shop can then access the BC authentication features of the personal information exchange framework and view the shopper's identity such as picture, signature, and others for identification (e.g., personal information about the shopper stored in the framework). As a further option, the shop can also be able to access the shopper's current e-point balance and add or subtract e-points from a user's e-point balance (via the framework) in accordance with the transaction conducted with the shopper.

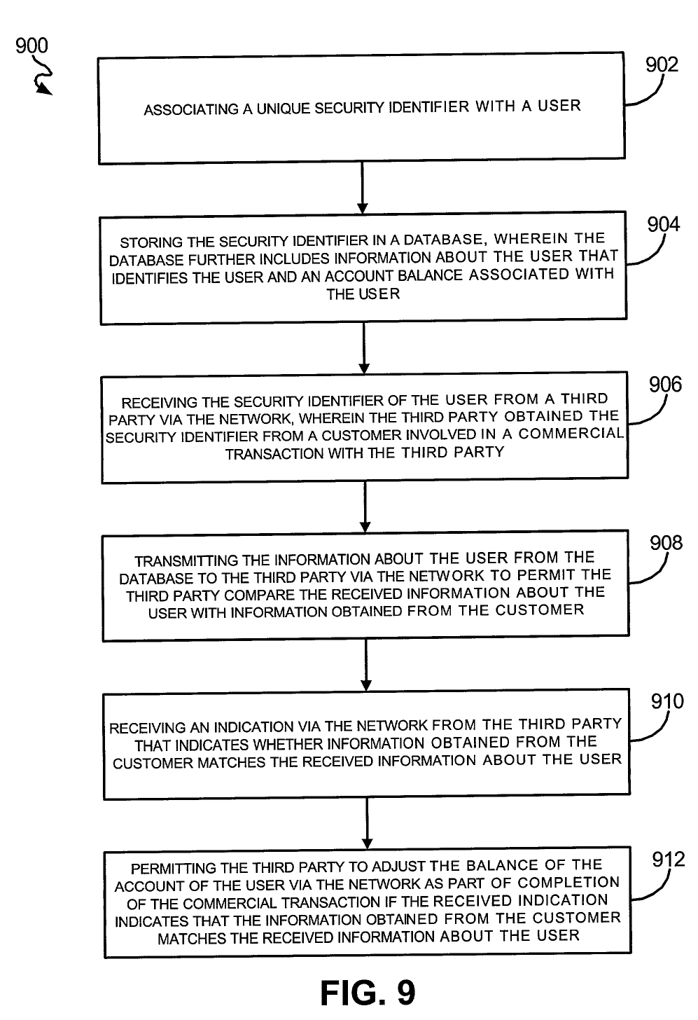

FIG. 9 is a flowchart of a process 900 for exchanging security information in a personal information exchange framework in accordance with an embodiment of the invention. In operation 902, a unique security identifier is associated with a user so that the security identifier is capable of being used to uniquely identify the user. In operation 904, the security identifier is stored in a database that also includes information about the user that identifies the user and an account balance of a financial account associated with the user. In operation 906, the security identifier of the user is received via the network from a third party that obtained the security identifier from a customer involved in a commercial transaction with the third party. The information about the user is transmitted from the database to the third party via the network in operation 908 to permit the third party compare the received information about the user with information obtained from the customer. In operation 910, an indication is received via the network from the third party that indicates whether information obtained from the customer matches the received information about the user. The third party is permitted to adjust the balance of the account of the user via the network as part of completion of the commercial transaction in operation 912 if the indication indicates that the information obtained from the customer matches the received information about the user.

In one aspect of this embodiment, the information about the user transmitted from the database may be encrypted. In another aspect of this embodiment, the security identifier may comprise at a numeric character string and/or an alphanumeric character string. In a further aspect of this embodiment, the network may be capable of communicating utilizing TCP/IP and/or IPX protocols.

In another illustrative application, the personal information exchange framework may be utilized for employee management in a business. In such an application, a business may generate a BC for each employee. Each BC can then be linked to a division/branch/organization/etc. of the business. As an option, the personal information exchange framework may even be installed into a server owned and operated by the business. With this application, employee activities may be monitored based on BC transactions conducted by the employee through the framework. For example, information about business meetings may be kept in a database in the framework. Organization changes in the business or changes in employee job descriptions may be reported to various parties (both internal and/or external to the business) by using the personal information exchange framework.

Secure e-mail delivery is another illustrative application of the personal information exchange framework. In this application a special access right may be defined: a mail access right (MAR). A MAR may be defined by one of the following: MAR=<my-pb-id, to-mail-address, time, period> or <my-pb-id, to-pb-id, time, period>. If an e-mail to a user is received by the framework from a party (e.g., an e-mail message from the e-mail address: yyy@yyy.com to the email address of the user defined in the framework: my-pb-id@mar.com), then the personal information exchange framework determines if the intended recipient (i.e., the user) gave a right to permit the forwarding of e-mail sent from the address yyy@yyy.com. If a right is determined to have been granted, then the personal information exchange framework transmits the email message to a forwarding email address of the user that was included as part of the personal information about user stored in the personal information exchange framework (e.g., the email is sent from: my-pb-id@mar.com to the forwarding email address my@my.com). Advantages of such an application of the personal information exchange framework may include the prevention of the receipt of e-mails sent from unknown sender addresses thereby helping protect a user from e-mails containing viruses and/or spam-type e-mails. It should further be noted that this application may also be applied for traditional non-electric form mail where incoming mail addressed to the user is first routed to an intermediary location which utilizes the personal information exchange framework to determine whether a particular piece of mail should be forwarded to the user at a forwarding address. The logging features of the personal information exchange frame may then also be utilized to maintain records containing information pertaining to all mail destined to the user that was received by the intermediary.

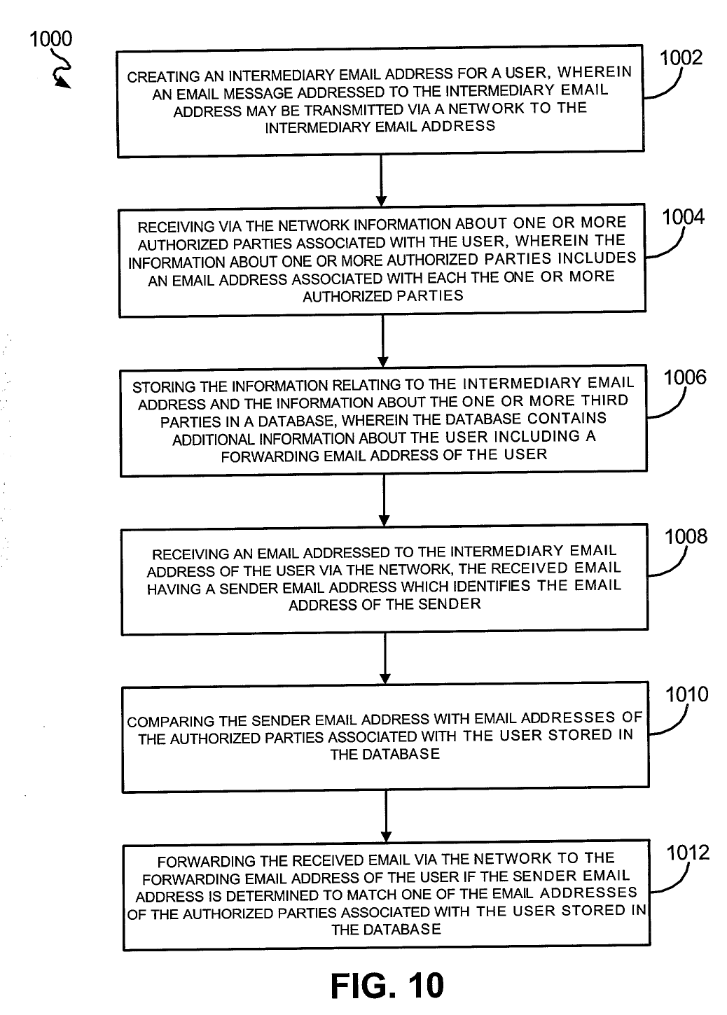

FIG. 10 is a flowchart of a process 1000 for exchanging email communication utilizing a personal information exchange framework. In operation 1002, an intermediary email address is created for a user to which an email message addressed to the intermediary email address may be transmitted via a network. Information about one or more authorized parties associated with the user is received via the network in operation 1004. The information about one or more authorized parties includes an email address associated with each the one or more authorized parties. The information relating to the intermediary email address and the information about the one or more third parties are stored in a database in operation 1006. The database also contains additional information about the user including a forwarding email address of the user. An email addressed to the intermediary email address of the user is subsequently received via the network in operation 1008. The received email has a sender email address which identifies the email address of the sender. In operation 1010, the sender email address is compared with email addresses of the authorized parties associated with the user stored in the database to determine if email messages from the sender are authorized to be forwarded to the forwarding email address of the user. If the sender email address is determined to match one of the email addresses of the authorized parties associated with the user stored in the database, then the received email is forwarded in operation 1012 via the network to the forwarding email address of the user.

In one aspect of this embodiment, a record of each received email addressed to the intermediary email address of the user may be stored in a log in the database. In such an aspect, the user may be permitted to access the log via the network to review the record stored therein. As a further option, the user may access the log utilizing a wireless device in communication with the network.

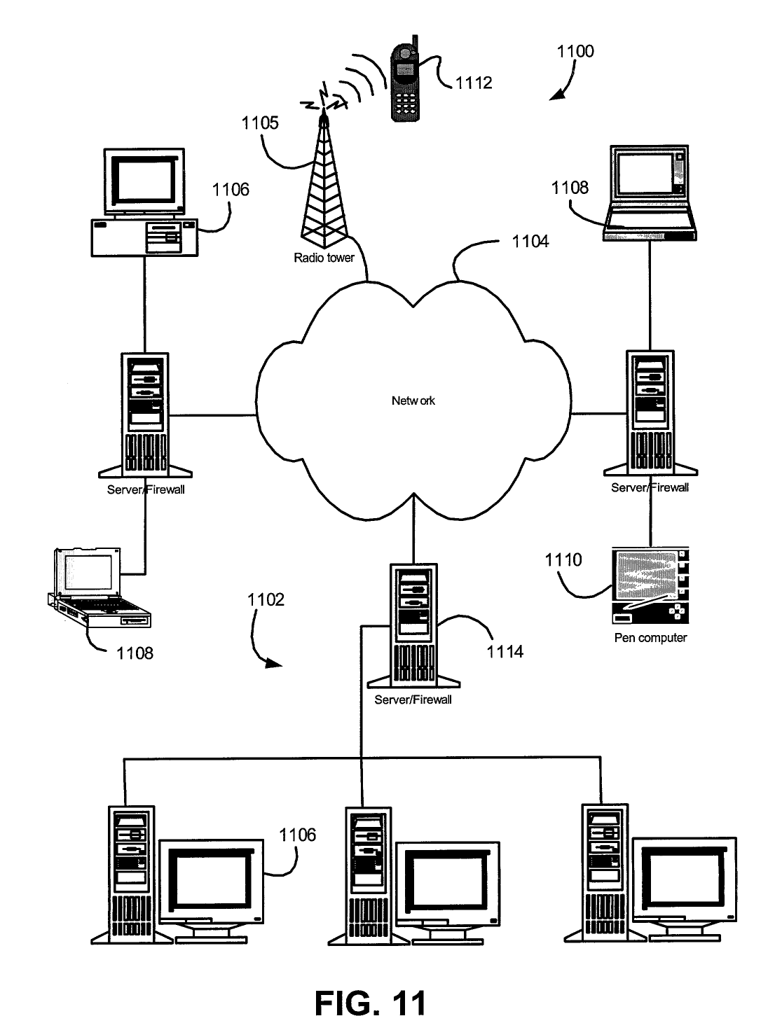

FIG. 11 illustrates an exemplary network system 1100 with a plurality of components 1102 in accordance with one embodiment of the present invention. As shown, such components include a network 1104 which take any form including, but not limited to a local area network, a wide area network such as the Internet, and a wireless network 1105. Coupled to the network 1104 is a plurality of computers which may take the form of desktop computers 1106, lap-top computers 1108, hand-held computers 1110 (including wireless devices 1112 such as wireless PDA's or mobile phones), or any other type of computing hardware/software. As an option, the various computers may be connected to the network 1104 by way of a server 1114 which may be equipped with a firewall for security purposes. It should be noted that any other type of hardware or software may be included in the system and be considered a component thereof.

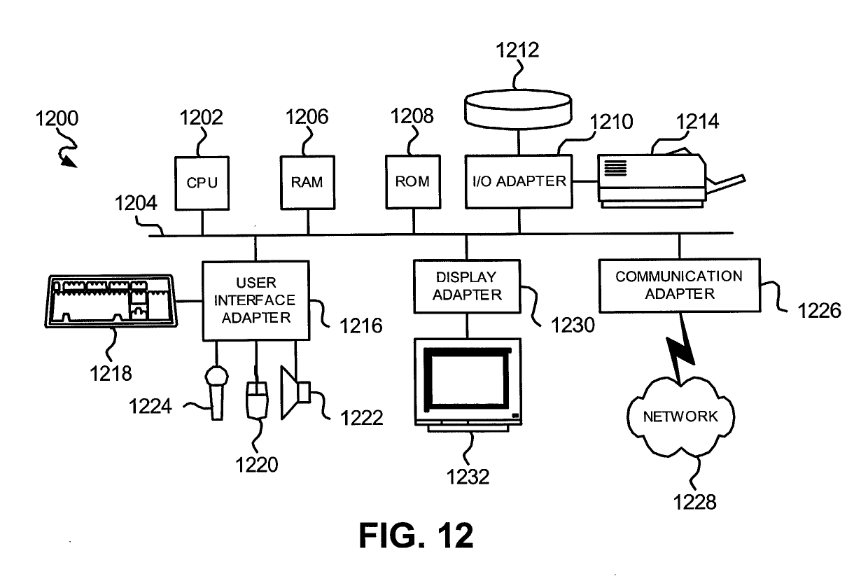

A representative hardware environment associated with the various components of FIG. 11 is depicted in FIG. 12. In the present description, the various sub-components of each of the components may also be considered components of the system. For example, particular software modules executed on any component of the system may also be considered components of the system. In particular, FIG. 12 illustrates an exemplary hardware configuration of a workstation 1200 having a central processing unit 1202, such as a microprocessor, and a number of other units interconnected via a system bus 1204.

The workstation shown in FIG. 12 includes a Random Access Memory (RAM) 1206, Read Only Memory (ROM) 1208, an I/O adapter 1210 for connecting peripheral devices such as, for example, disk storage units 1212 and printers 1214 to the bus 1204, a user interface adapter 1216 for connecting various user interface devices such as, for example, a keyboard 1218, a mouse 1220, a speaker 1222, a microphone 1224, and/or other user interface devices such as a touch screen or a digital camera to the bus 1204, a communication adapter 1226 for connecting the workstation 1200 to a communication network 1228 (e.g., a data processing network) and a display adapter 1230 for connecting the bus 1204 to a display device 1232. The workstation may utilize an operating system such as the Microsoft Windows NT or Windows/95 Operating System (OS), the IBM OS/2 operating system, the MAC OS, or UNIX operating system. Those skilled in the art will appreciate that the present invention may also be implemented on platforms and operating systems other than those mentioned.

An embodiment of the present invention may also be written using Java, C, and the C++ language and utilize object oriented programming methodology. Object oriented programming (OOP) has become increasingly used to develop complex applications. As OOP moves toward the mainstream of software design and development, various software solutions require adaptation to make use of the benefits of OOP. A need exists for these principles of OOP to be applied to a messaging interface of an electronic messaging system such that a set of OOP classes and objects for the messaging interface can be provided.

OOP is a process of developing computer software using objects, including the steps of analyzing the problem, designing the system, and constructing the program. An object is a software package that contains both data and a collection of related structures and procedures. Since it contains both data and a collection of structures and procedures, it can be visualized as a self-sufficient component that does not require other additional structures, procedures or data to perform its specific task. OOP, therefore, views a computer program as a collection of largely autonomous components, called objects, each of which is responsible for a specific task. This concept of packaging data, structures, and procedures together in one component or module is called encapsulation.

In general, OOP components are reusable software modules which present an interface that conforms to an object model and which are accessed at run-time through a component integration architecture. A component integration architecture is a set of architecture mechanisms which allow software modules in different process spaces to utilize each others capabilities or functions. This is generally done by assuming a common component object model on which to build the architecture. It is worthwhile to differentiate between an object and a class of objects at this point. An object is a single instance of the class of objects, which is often just called a class. A class of objects can be viewed as a blueprint, from which many objects can be formed.

OOP allows the programmer to create an object that is a part of another object. For example, the object representing a piston engine is said to have a composition-relationship with the object representing a piston. In reality, a piston engine comprises a piston, valves and many other components; the fact that a piston is an element of a piston engine can be logically and semantically represented in OOP by two objects.

OOP also allows creation of an object that “depends from” another object. If there are two objects, one representing a piston engine and the other representing a piston engine wherein the piston is made of ceramic, then the relationship between the two objects is not that of composition. A ceramic piston engine does not make up a piston engine. Rather it is merely one kind of piston engine that has one more limitation than the piston engine; its piston is made of ceramic. In this case, the object representing the ceramic piston engine is called a derived object, and it inherits all of the aspects of the object representing the piston engine and adds further limitation or detail to it. The object representing the ceramic piston engine “depends from” the object representing the piston engine. The relationship between these objects is called inheritance.

When the object or class representing the ceramic piston engine inherits all of the aspects of the objects representing the piston engine, it inherits the thermal characteristics of a standard piston defined in the piston engine class. However, the ceramic piston engine object overrides these ceramic specific thermal characteristics, which are typically different from those associated with a metal piston. It skips over the original and uses new functions related to ceramic pistons. Different kinds of piston engines have different characteristics, but may have the same underlying functions associated with it (e.g., how many pistons in the engine, ignition sequences, lubrication, etc.). To access each of these functions in any piston engine object, a programmer would call the same functions with the same names, but each type of piston engine may have different/overriding implementations of functions behind the same name. This ability to hide different implementations of a function behind the same name is called polymorphism and it greatly simplifies communication among objects.

With the concepts of composition-relationship, encapsulation, inheritance and polymorphism, an object can represent just about anything in the real world. In fact, one's logical perception of the reality is the only limit on determining the kinds of things that can become objects in object-oriented software. Some typical categories are as follows:

Objects can represent physical objects, such as automobiles in a traffic-flow simulation, electrical components in a circuit-design program, countries in an economics model, or aircraft in an air-traffic-control system.

Objects can represent elements of the computer-user environment such as windows, menus or graphics objects.

An object can represent an inventory, such as a personnel file or a table of the latitudes and longitudes of cities.

An object can represent user-defined data types such as time, angles, and complex numbers, or points on the plane.

With this enormous capability of an object to represent just about any logically separable matters, OOP allows the software developer to design and implement a computer program that is a model of some aspects of reality, whether that reality is a physical entity, a process, a system, or a composition of matter. Since the object can represent anything, the software developer can create an object which can be used as a component in a larger software project in the future.

If 90% of a new OOP software program consists of proven, existing components made from preexisting reusable objects, then only the remaining 10% of the new software project has to be written and tested from scratch. Since 90% already came from an inventory of extensively tested reusable objects, the potential domain from which an error could originate is 10% of the program. As a result, OOP enables software developers to build objects out of other, previously built objects.

This process closely resembles complex machinery being built out of assemblies and sub-assemblies. OOP technology, therefore, makes software engineering more like hardware engineering in that software is built from existing components, which are available to the developer as objects. All this adds up to an improved quality of the software as well as an increased speed of its development.

Programming languages are beginning to fully support the OOP principles, such as encapsulation, inheritance, polymorphism, and composition-relationship. With the advent of the C++ language, many commercial software developers have embraced OOP. C++ is an OOP language that offers a fast, machine-executable code. Furthermore, C++ is suitable for both commercial-application and systems-programming projects. For now, C++ appears to be the most popular choice among many OOP programmers, but there is a host of other OOP languages, such as Smalltalk, Common Lisp Object System (CLOS), and Eiffel. Additionally, OOP capabilities are being added to more traditional popular computer programming languages such as Pascal.

The benefits of object classes can be summarized, as follows:

Objects and their corresponding classes break down complex programming problems into many smaller, simpler problems.

Encapsulation enforces data abstraction through the organization of data into small, independent objects that can communicate with each other. Encapsulation protects the data in an object from accidental damage, but allows other objects to interact with that data by calling the object's member functions and structures.

Subclassing and inheritance make it possible to extend and modify objects through deriving new kinds of objects from the standard classes available in the system. Thus, new capabilities are created without having to start from scratch.

Polymorphism and multiple inheritance make it possible for different programmers to mix and match characteristics of many different classes and create specialized objects that can still work with related objects in predictable ways.

Class hierarchies and containment hierarchies provide a flexible mechanism for modeling real-world objects and the relationships among them.

Libraries of reusable classes are useful in many situations, but they also have some limitations. For example:

Complexity. In a complex system, the class hierarchies for related classes can become extremely confusing, with many dozens or even hundreds of classes.

Flow of control. A program written with the aid of class libraries is still responsible for the flow of control (i.e., it must control the interactions among all the objects created from a particular library). The programmer has to decide which functions to call at what times for which kinds of objects.

Duplication of effort. Although class libraries allow programmers to use and reuse many small pieces of code, each programmer puts those pieces together in a different way. Two different programmers can use the same set of class libraries to write two programs that do exactly the same thing but whose internal structure (i.e., design) may be quite different, depending on hundreds of small decisions each programmer makes along the way. Inevitably, similar pieces of code end up doing similar things in slightly different ways and do not work as well together as they should.

Class libraries are very flexible. As programs grow more complex, more programmers are forced to reinvent basic solutions to basic problems over and over again. A relatively new extension of the class library concept is to have a framework of class libraries. This framework is more complex and consists of significant collections of collaborating classes that capture both the small scale patterns and major mechanisms that implement the common requirements and design in a specific application domain. They were first developed to free application programmers from the chores involved in displaying menus, windows, dialog boxes, and other standard user interface elements for personal computers.

Frameworks also represent a change in the way programmers think about the interaction between the code they write and code written by others. In the early days of procedural programming, the programmer called libraries provided by the operating system to perform certain tasks, but basically the program executed down the page from start to finish, and the programmer was solely responsible for the flow of control. This was appropriate for printing out paychecks, calculating a mathematical table, or solving other problems with a program that executed in just one way.

The development of graphical user interfaces began to turn this procedural programming arrangement inside out. These interfaces allow the user, rather than program logic, to drive the program and decide when certain actions should be performed. Today, most personal computer software accomplishes this by means of an event loop which monitors the mouse, keyboard, and other sources of external events and calls the appropriate parts of the programmer's code according to actions that the user performs. The programmer no longer determines the order in which events occur. Instead, a program is divided into separate pieces that are called at unpredictable times and in an unpredictable order. By relinquishing control in this way to users, the developer creates a program that is much easier to use. Nevertheless, individual pieces of the program written by the developer still call libraries provided by the operating system to accomplish certain tasks, and the programmer must still determine the flow of control within each piece after it's called by the event loop. Application code still “sits on top of” the system.

Even event loop programs require programmers to write a lot of code that should not need to be written separately for every application. The concept of an application framework carries the event loop concept further. Instead of dealing with all the nuts and bolts of constructing basic menus, windows, and dialog boxes and then making these things all work together, programmers using application frameworks start with working application code and basic user interface elements in place. Subsequently, they build from there by replacing some of the generic capabilities of the framework with the specific capabilities of the intended application.

Application frameworks reduce the total amount of code that a programmer has to write from scratch. However, because the framework is really a generic application that displays windows, supports copy and paste, and so on, the programmer can also relinquish control to a greater degree than event loop programs permit. The framework code takes care of almost all event handling and flow of control, and the programmer's code is called only when the framework needs it (e.g., to create or manipulate a proprietary data structure).

A programmer writing a framework program not only relinquishes control to the user (as is also true for event loop programs), but also relinquishes the detailed flow of control within the program to the framework. This approach allows the creation of more complex systems that work together in interesting ways, as opposed to isolated programs, having custom code, being created over and over again for similar problems.

Thus, as is explained above, a framework basically is a collection of cooperating classes that make up a reusable design solution for a given problem domain. It typically includes objects that provide default behavior (e.g., for menus and windows), and programmers use it by inheriting some of that default behavior and overriding other behavior so that the framework calls application code at the appropriate times.

There are three main differences between frameworks and class libraries:

Behavior versus protocol. Class libraries are essentially collections of behaviors that you can call when you want those individual behaviors in your program. A framework, on the other hand, provides not only behavior but also the protocol or set of rules that govern the ways in which behaviors can be combined, including rules for what a programmer is supposed to provide versus what the framework provides.

Call versus override. With a class library, the code the programmer instantiates objects and calls their member functions. It's possible to instantiate and call objects in the same way with a framework (i.e., to treat the framework as a class library), but to take full advantage of a framework's reusable design, a programmer typically writes code that overrides and is called by the framework. The framework manages the flow of control among its objects. Writing a program involves dividing responsibilities among the various pieces of software that are called by the framework rather than specifying how the different pieces should work together.

Implementation versus design. With class libraries, programmers reuse only implementations, whereas with frameworks, they reuse design. A framework embodies the way a family of related programs or pieces of software work. It represents a generic design solution that can be adapted to a variety of specific problems in a given domain. For example, a single framework can embody the way a user interface works, even though two different user interfaces created with the same framework might solve quite different interface problems.

Thus, through the development of frameworks for solutions to various problems and programming tasks, significant reductions in the design and development effort for software can be achieved. An embodiment of the invention utilizes HyperText Markup Language (HTML) to implement documents on the Internet together with a general-purpose secure communication protocol for a transport medium between the client and the server. HTTP or other protocols could be readily substituted for HTML without undue experimentation. Information on these products is available in T. Berners-Lee, D. Connoly, “RFC 1866: Hypertext Markup Language—2.0” (Nov. 1995); and R. Fielding, H, Frystyk, T. Berners-Lee, J. Gettys and J. C. Mogul, “Hypertext Transfer Protocol—HTTP/1.1: HTTP Working Group Internet Draft” (May 2, 1996). HTML is a simple data format used to create hypertext documents that are portable from one platform to another. HTML documents are SGML documents with generic semantics that are appropriate for representing information from a wide range of domains. HTML has been in use by the World-Wide Web global information initiative since 1990. HTML is an application of ISO Standard 8879; 1986 Information Processing Text and Office Systems; Standard Generalized Markup Language (SGML).

To date, Web development tools have been limited in their ability to create dynamic Web applications which span from client to server and interoperate with existing computing resources. Until recently, HTML has been the dominant technology used in development of Web-based solutions. However, HTML has proven to be inadequate in the following areas:

Poor performance;

Restricted user interface capabilities;

Can only produce static Web pages;

Lack of interoperability with existing applications and data; and

Inability to scale.

Sun Microsystems's Java language solves many of the client-side problems by:

Improving performance on the client side;

Enabling the creation of dynamic, real-time Web applications; and

Providing the ability to create a wide variety of user interface components.

With Java, developers can create robust User Interface (UI) components. Custom “widgets” (e.g., real-time stock tickers, animated icons, etc.) can be created, and client-side performance is improved. Unlike HTML, Java supports the notion of client-side validation, offloading appropriate processing onto the client for improved performance. Dynamic, real-time Web pages can be created. Using the above-mentioned custom UI components, dynamic Web pages can also be created.

Sun's Java language has emerged as an industry-recognized language for “programming the Internet.” Sun defines Java as: “a simple, object-oriented, distributed, interpreted, robust, secure, architecture-neutral, portable, high-performance, multithreaded, dynamic, buzzword-compliant, general-purpose programming language. Java supports programming for the Internet in the form of platform-independent Java applets.” Java applets are small, specialized applications that comply with Sun's Java Application Programming Interface (API) allowing developers to add “interactive content” to Web documents (e.g., simple animations, page adornments, basic games, etc.). Applets execute within a Java-compatible browser (e.g., Netscape Navigator) by copying code from the server to client. From a language standpoint, Java's core feature set is based on C++. Sun's Java literature states that Java is basically, “C++ with extensions from Objective C for more dynamic method resolution.”

Another technology that provides similar function to Java is provided by Microsoft and ActiveX Technologies, to give developers and Web designers wherewithal to build dynamic content for the Internet and personal computers. ActiveX includes tools for developing animation, 3-D virtual reality, video and other multimedia content. The tools use Internet standards, work on multiple platforms, and are being supported by over 100 companies. The group's building blocks are called ActiveX Controls, small, fast components that enable developers to embed parts of software in hypertext markup language (HTML) pages. ActiveX Controls work with a variety of programming languages including Microsoft Visual C++, Borland Delphi, Microsoft Visual Basic programming system and, in the future, Microsoft's development tool for Java, code named “Jakarta.” ActiveX Technologies also includes ActiveX Server Framework, allowing developers to create server applications. One of ordinary skill in the art readily recognizes that ActiveX could be substituted for Java without undue experimentation to practice the invention.

Transmission Control Protocol/Internet Protocol (TCP/IP) is a basic communication language or protocol of the Internet. It can also be used as a communications protocol in the private networks called intranet and in extranet. When you are set up with direct access to the Internet, your computer is provided with a copy of the TCP/IP program just as every other computer that you may send messages to or get information from also has a copy of TCP/IP.

TCP/IP is a two-layering program. The higher layer, Transmission Control Protocol (TCP), manages the assembling of a message or file into smaller packet that are transmitted over the Internet and received by a TCP layer that reassembles the packets into the original message. The lower layer, Internet Protocol (IP), handles the address part of each packet so that it gets to the right destination. Each gateway computer on the network checks this address to see where to forward the message. Even though some packets from the same message are routed differently than others, they'll be reassembled at the destination.

TCP/IP uses a client/server model of communication in which a computer user (a client) requests and is provided a service (such as sending a Web page) by another computer (a server) in the network. TCP/IP communication is primarily point-to-point, meaning each communication is from one point (or host computer) in the network to another point or host computer. TCP/IP and the higher-level applications that use it are collectively said to be “stateless” because each client request is considered a new request unrelated to any previous one (unlike ordinary phone conversations that require a dedicated connection for the call duration). Being stateless frees network paths so that everyone can use them continuously. (Note that the TCP layer itself is not stateless as far as any one message is concerned. Its connection remains in place until all packets in a message have been received).

Many Internet users are familiar with the even higher layer application protocols that use TCP/IP to get to the Internet. These include the World Wide Web's Hypertext Transfer Protocol (HTTP), the File Transfer Protocol (FTP), Telnet which lets you logon to remote computers, and the Simple Mail Transfer Protocol (SMTP). These and other protocols are often packaged together with TCP/IP as a “suite.”

Personal computer users usually get to the Internet through the Serial Line Internet Protocol (SLIP) or the Point-to-Point Protocol. These protocols encapsulate the IP packets so that they can be sent over a dial-up phone connection to an access provider's modem.

Protocols related to TCP/IP include the User Datagram Protocol (UDP), which is used instead of TCP for special purposes. Other protocols are used by network host computers for exchanging router information. These include the Internet Control Message Protocol (ICMP), the Interior Gateway Protocol (IGP), the Exterior Gateway Protocol (EGP), and the Border Gateway Protocol (BGP).

Internetwork Packet Exchange (IPX)is a networking protocol from Novell that interconnects networks that use Novell's NetWare clients and servers. IPX is a datagram or packet protocol. IPX works at the network layer of communication protocols and is connectionless (that is, it doesn't require that a connection be maintained during an exchange of packets as, for example, a regular voice phone call does).

Packet acknowledgment is managed by another Novell protocol, the Sequenced Packet Exchange (SPX). Other related Novell NetWare protocols are: the Routing Information Protocol (RIP), the Service Advertising Protocol (SAP), and the NetWare Link Services Protocol (NLSP).

A virtual private network (VPN) is a private data network that makes use of the public telecommunication infrastructure, maintaining privacy through the use of a tunneling protocol and security procedures. A virtual private network can be contrasted with a system of owned or leased lines that can only be used by one company. The idea of the VPN is to give the company the same capabilities at much lower cost by using the shared public infrastructure rather than a private one. Phone companies have provided secure shared resources for voice messages. A virtual private network makes it possible to have the same secure sharing of public resources for data.

Using a virtual private network involves encryption data before sending it through the public network and decrypting it at the receiving end. An additional level of security involves encrypting not only the data but also the originating and receiving network addresses. Microsoft, 3Com, and several other companies have developed the Point-to-Point Tunneling Protocol (PPP) and Microsoft has extended Windows NT to support it. VPN software is typically installed as part of a company's firewall server.

Wireless refers to a communications, monitoring, or control system in which electromagnetic radiation spectrum or acoustic waves carry a signal through atmospheric space rather than along a wire. In most wireless systems, radio frequency (RF) or infrared transmission (IR) waves are used. Some monitoring devices, such as intrusion alarms, employ acoustic waves at frequencies above the range of human hearing.

Early experimenters in electromagnetic physics dreamed of building a so-called wireless telegraph. The first wireless telegraph transmitters went on the air in the early years of the 20th century. Later, as amplitude modulation (AM) made it possible to transmit voices and music via wireless, the medium came to be called radio. With the advent of television, fax, data communication, and the effective use of a larger portion of the electromagnetic spectrum, the original term has been brought to life again.

Common examples of wireless equipment in use today include the Global Positioning System, cellular telephone phones and pagers, cordless computer accessories (for example, the cordless mouse), home-entertainment-system control boxes, remote garage-door openers, two-way radios, and baby monitors. An increasing number of companies and organizations are using wireless LAN. Wireless transceivers are available for connection to portable and notebook computers, allowing Internet access in selected cities without the need to locate a telephone jack. Eventually, it will be possible to link any computer to the Internet via satellite, no matter where in the world the computer might be located.

Bluetooth is a computing and telecommunications industry specification that describes how mobile phones, computers, and personal digital assistants (PDA's) can easily interconnect with each other and with home and business phones and computers using a short-range wireless connection. Each device is equipped with a microchip transceiver that transmits and receives in a previously unused frequency band of 2.45 GHz that is available globally (with some variation of bandwidth in different countries). In addition to data, up to three voice channels are available. Each device has a unique 48-bit address from the IEEE 802 standard. Connections can be point-to-point or multipoint. The maximum range is 10 meters. Data can be presently be exchanged at a rate of 1 megabit per second (up to 2 Mbps in the second generation of the technology). A frequency hop scheme allows devices to communicate even in areas with a great deal of electromagnetic interference. Built-in encryption and verification is provided.

Encryption is the conversion of data into a form, called a ciphertext, that cannot be easily understood by unauthorized people. Decryption is the process of converting encrypted data back into its original form, so it can be understood.

The use of encryption/decryption is as old as the art of communication. In wartime, a cipher, often incorrectly called a “code,” can be employed to keep the enemy from obtaining the contents of transmissions (technically, a code is a means of representing a signal without the intent of keeping it secret; examples are Morse code and ASCII). Simple ciphers include the substitution of letters for numbers, the rotation of letters in the alphabet, and the “scrambling” of voice signals by inverting the sideband frequencies. More complex ciphers work according to sophisticated computer algorithm that rearrange the data bits in digital signals.

In order to easily recover the contents of an encrypted signal, the correct decryption key is required. The key is an algorithm that “undoes” the work of the encryption algorithm. Alternatively, a computer can be used in an attempt to “break” the cipher. The more complex the encryption algorithm, the more difficult it becomes to eavesdrop on the communications without access to the key.

Rivest-Shamir-Adleman (RSA) is an Internet encryption and authentication system that uses an algorithm developed in 1977 by Ron Rivest, Adi Shamir, and Leonard Adleman. The RSA algorithm is a commonly used encryption and authentication algorithm and is included as part of the Web browser from Netscape and Microsoft. It's also part of Lotus Notes, Intuit's Quicken, and many other products. The encryption system is owned by RSA Security.

The RSA algorithm involves multiplying two large prime numbers (a prime number is a number divisible only by that number and 1) and through additional operations deriving a set of two numbers that constitutes the public key and another set that is the private key. Once the keys have been developed, the original prime numbers are no longer important and can be discarded. Both the public and the private keys are needed for encryption/decryption but only the owner of a private key ever needs to know it. Using the RSA system, the private key never needs to be sent across the Internet.

The private key is used to decrypt text that has been encrypted with the public key. Thus, if I send you a message, I can find out your public key (but not your private key) from a central administrator and encrypt a message to you using your public key. When you receive it, you decrypt it with your private key. In addition to encrypting messages (which ensures privacy), you can authenticate yourself to me (so I know that it is really you who sent the message) by using your private key to encrypt a digital certificate. When I receive it, I can use your public key to decrypt it.

A database is a collection of data that is organized so that its contents can easily be accessed, managed, and updated. One type of database is a relational database which comprises a tabular database in which data is defined so that it can be reorganized and accessed in a number of different ways. A distributed database is one that can be dispersed or replicated among different points in a network. An object-oriented programming database is one that is congruent with the data defined in object classes and subclasses.

Databases contain aggregations of data records or files, such as sales transactions, product catalogs and inventories, and customer profiles. Typically, a database manager provides users the capabilities of controlling read/write access, specifying report generation, and analyzing usage. Structured Query Language is a standard language for making interactive queries from and updating a database.

Extensible Markup Language (XML) is a flexible way to create common information formats and share both the format and the data on the World Wide Web, intranets, and elsewhere. For example, computer makers might agree on a standard or common way to describe the information about a computer product (processor speed, memory size, and so forth) and then describe the product information format with XML. Such a standard way of describing data would enable a user to send an intelligent agent (a program) to each computer maker's Web site, gather data, and then make a valid comparison. XML can be used by any individual or group of individuals or companies that wants to share information in a consistent way.

XML, a formal recommendation from the World Wide Web Consortium (W3C), is similar to the language of today's Web pages, the Hypertext Markup Language (HTML). Both XML and HTML contain markup symbols to describe the contents of a page or file. HTML, however, describes the content of a Web page (mainly text and graphic images) only in terms of how it is to be displayed and interacted with. For example, the letter “p” placed within markup tags starts a new paragraph. XML describes the content in terms of what data is being described. For example, the word “phonenum” placed within markup tags could indicate that the data that followed was a phone number. This means that an XML file can be processed purely as data by a program or it can be stored with similar data on another computer or, like an HTML file, that it can be displayed. For example, depending on how the application in the receiving computer wanted to handle the phone number, it could be stored, displayed, or dialed.

XML is “extensible” because, unlike HTML, the markup symbols are unlimited and self-defining. XML is actually a simpler and easier-to-use subset of the Standard Generalized Markup Language (SGML), the standard for how to create a document structure. HTML and XML may be used together in many Web applications. XML markup, for example, may appear within an HTML page.

Early applications of XML include Microsoft's Channel Definition Format (CDF), which describes a channel, a portion of a Web site that has been downloaded to your hard disk and is then is updated periodically as information changes. A specific CDF file contains data that specifies an initial Web page and how frequently it is updated. Another early application is ChartWare, which uses XML as a way to describe medical charts so that they can be shared by doctors.

VoiceXML or VXML is an application of the Extensible Markup Language (XML) which, when combined with voice recognition technology, enables interactive access to the Web through the telephone or a voice-driven browser. An individual session works through a combination of voice recognition and keypad entry. VoiceXML 1.0 was created through a collaboration of AT&T, IBM, Lucent Technologies, and Motorola. Using XML, a programmer can enable voice recognition through the addition of a few simple tags.

VXML allows people with an ordinary voice telephone to access the Internet to get and send email, check sports scores, make reservations, and so on. VXML also can support natural language, which means that the user is not locked into a limited script, but can speak naturally. In what is called a “modeless” or “conversational” mode, the user can even interrupt the system with an out-of-context question and thus redirect the session. A goal is to make the exchange as natural as possible, as if two humans were interacting.

Based on the foregoing specification, embodiments of the invention may be implemented using computer programming or engineering techniques including computer software, firmware, hardware or any combination or subset thereof. Any such resulting program, having computer-readable code means, may be embodied or provided within one or more computer-readable media, thereby making a computer program product, i.e., an article of manufacture, according to the invention. The computer readable media may be, for instance, a fixed (hard) drive, diskette, optical disk, magnetic tape, semiconductor memory such as read-only memory (ROM), etc., or any transmitting/receiving medium such as the Internet or other communication network or link. The article of manufacture containing the computer code may be made and/or used by executing the code directly from one medium, by copying the code from one medium to another medium, or by transmitting the code over a network.

One skilled in the art of computer science will easily be able to combine the software created as described with appropriate general purpose or special purpose computer hardware to create a computer system or computer sub-system embodying the method of the invention.

While various embodiments have been described above, it should be understood that they have been presented by way of example only, and not limitation. Thus, the breadth and scope of a preferred embodiment should not be limited by any of the above described exemplary embodiments, but should be defined only in accordance with the following claims and their equivalents.

What is claimed is:

1. A method for exchanging a memo in an information exchange framework, comprising:
a) maintaining a database having information about a plurality of users, wherein the personal information about each user including a public identifier associated with the particular user;
b) receiving a request via a network to facilitate a meeting, wherein the request includes a memo for presentation at the meeting and an invitation list of public identifiers of users to be invited to the meeting;
c) storing the memo and the list of public identifiers in the database;
d) retrieving information about each user to be invited to the meeting from the database utilizing the public identifiers of the invitation list, wherein the retrieved information about each user includes information about a network address for contacting the user;
e) generating a meeting identifier in response to the request, the meeting identifier including a link to the memo stored in the database;
f) transmitting the meeting identifier via the network to the network addresses of the users invited to the meeting;
g) receiving the meeting identifier from at least one of the users invited to the meeting via the network; and
h) permitting the users from which the meeting identifier has been received to access the memo in the database via the network.

2. The method of claim 1, wherein at least one of the users receives the meeting identifier using a wireless device in communication with the network.

3. The method of claim 1, wherein the meeting identifier comprises at least one of a numeric character string and an alphanumeric character string.

4. The method of claim 1, wherein the network is capable of communicating utilizing at least one of TCP/IP and IPX protocols.

5. A system for exchanging a memo in an information exchange framework, comprising:
a) logic for maintaining a database having information about a plurality of users, wherein the personal information about each user including a public identifier associated with the particular user;
b) logic for receiving a request via a network to facilitate a meeting, wherein the request includes a memo for presentation at the meeting and an invitation list of public identifiers of users to be invited to the meeting;
c) logic for storing the memo and the list of public identifiers in the database;
d) logic for retrieving information about each user to be invited to the meeting from the database utilizing the public identifiers of the invitation list, wherein the retrieved information about each user includes information about a network address for contacting the user;
e) logic for generating a meeting identifier in response to the request, the meeting identifier including a link to the memo stored in the database;
f) logic for transmitting the meeting identifier via the network to the network addresses of the users invited to the meeting;
g) logic for receiving the meeting identifier from at least one of the users invited to the meeting via the network; and
h) logic for permitting the users from which the meeting identifier has been received to access the memo in the database via the network.

6. A computer program product for exchanging a memo in an information exchange framework, comprising:
a) computer code for maintaining a database having information about a plurality of users, wherein the personal information about each user including a public identifier associated with the particular user;
b) computer code for receiving a request via a network to facilitate a meeting, wherein the request includes a memo for presentation at the meeting and an invitation list of public identifiers of users to be invited to the meeting;
c) computer code for storing the memo and the list of public identifiers in the database;
d) computer code for retrieving information about each user to be invited to the meeting from the database utilizing the public identifiers of the invitation list, wherein the retrieved information about each user includes information about a network address for contacting the user;
e) computer code for generating a meeting identifier in response to the request, the meeting identifier including a link to the memo stored in the database;
f) computer code for transmitting the meeting identifier via the network to the network addresses of the users invited to the meeting;
g) computer code for receiving the meeting identifier from at least one of the users invited to the meeting via the network; and
h) computer code for permitting the users from which the meeting identifier has been received to access the memo in the database via the network.

7. A method for exchanging security information in an information exchange framework, comprising:
a) associating a unique security identifier with a user;
b) storing the security identifier in a database, wherein the database further includes information about the user that identifies the user and an account balance associated with the user;
c) receiving the security identifier of the user from a third party via the network, wherein the third party obtained the security identifier from a customer involved in a commercial transaction with the third party;
d) transmitting the information about the user from the database to the third party via the network to permit the third party compare the received information about the user with information obtained from the customer;
e) receiving an indication via the network from the third party that indicates whether information obtained from the customer matches the received information about the user; and
f) permitting the third party to adjust the balance of the account of the user via the network as part of completion of the commercial transaction if the received indication indicates that the information obtained from the customer matches the received information about the user.

8. The method of claim 7, wherein the information about the user transmitted from the database is encrypted.

9. The method of claim 7, wherein the security identifier comprises at least one of a numeric character string and an alphanumeric character string.

10. The method of claim 7, wherein the network is capable of communicating utilizing at least one of TCP/IP and IPX protocols.

11. A system for exchanging security information in an information exchange framework, comprising:
a) logic for associating a unique security identifier with a user;
b) logic for storing the security identifier in a database, wherein the database further includes information about the user that identifies the user and an account balance associated with the user;
c) logic for receiving the security identifier of the user from a third party via the network, wherein the third party obtained the security identifier from a customer involved in a commercial transaction with the third party;
d) logic for transmitting the information about the user from the database to the third party via the network to permit the third party compare the received information about the user with information obtained from the customer;
e) logic for receiving an indication via the network from the third party that indicates whether information obtained from the customer matches the received information about the user; and
f) logic for permitting the third party to adjust the balance of the account of the user via the network as part of completion of the commercial transaction if the received indication indicates that the information obtained from the customer matches the received information about the user.

12. A computer program product for exchanging security information in an information exchange framework, comprising:
a) computer code for associating a unique security identifier with a user;
b) computer code for storing the security identifier in a database, wherein the database further includes information about the user that identifies the user and an account balance associated with the user;
c) computer code for receiving the security identifier of the user from a third party via the network, wherein the third party obtained the security identifier from a customer involved in a commercial transaction with the third party;
d) computer code for transmitting the information about the user from the database to the third party via the network to permit the third party compare the received information about the user with information obtained from the customer;
e) computer code for receiving an indication via the network from the third party that indicates whether information obtained from the customer matches the received information about the user; and
f) computer code for permitting the third party to adjust the balance of the account of the user via the network as part of completion of the commercial transaction if the received indication indicates that the information obtained from the customer matches the received information about the user.

13. A method for exchanging email communication utilizing an information exchange framework, comprising:
a) creating an intermediary email address for a user, wherein an email message addressed to the intermediary email address may be transmitted via a network to the intermediary email address;
b) receiving via the network information about one or more authorized parties associated with the user, wherein the information about one or more authorized parties includes an email address associated with each the one or more authorized parties;
c) storing the information relating to the intermediary email address and the information about the one or more third parties in a database, wherein the database contains additional information about the user including a forwarding email address of the user;
d) receiving an email addressed to the intermediary email address of the user via the network, the received email having a sender email address which identifies the email address of the sender;
e) comparing the sender email address with email addresses of the authorized parties associated with the user stored in the database; and
f) forwarding the received email via the network to the forwarding email address of the user if the sender email address is determined to match one of the email addresses of the authorized parties associated with the user stored in the database.

14. The method of claim 13, wherein a record of each received email addressed to the intermediary email address of the user is stored in a log in the database.

15. The method of claim 14, wherein the user is permitted to access the log via the network to review the record stored therein.

16. The method of claim 15, wherein the user accesses the log utilizing a wireless device in communication with the network.

17. A system for exchanging email communication utilizing an information exchange framework, comprising:
a) logic for creating an intermediary email address for a user, wherein an email message addressed to the intermediary email address may be transmitted via a network to the intermediary email address;
b) logic for receiving via the network information about one or more authorized parties associated with the user, wherein the information about one or more authorized parties includes an email address associated with each the one or more authorized parties;
c) logic for storing the information relating to the intermediary email address and the information about the one or more third parties in a database, wherein the database contains additional information about the user including a forwarding email address of the user;
d) logic for receiving an email addressed to the intermediary email address of the user via the network, the received email having a sender email address which identifies the email address of the sender;
e) logic for comparing the sender email address with email addresses of the authorized parties associated with the user stored in the database; and
f) logic for forwarding the received email via the network to the forwarding email address of the user if the sender email address is determined to match one of the email addresses of the authorized parties associated with the user stored in the database.

18. A computer program product for exchanging email communication utilizing an information exchange framework, comprising:
a) computer code for creating an intermediary email address for a user, wherein an email message addressed to the intermediary email address may be transmitted via a network to the intermediary email address;
b) computer code for receiving via the network information about one or more authorized parties associated with the user, wherein the information about one or more authorized parties includes an email address associated with each the one or more authorized parties;
c) computer code for storing the information relating to the intermediary email address and the information about the one or more third parties in a database, wherein the database contains additional information about the user including a forwarding email address of the user;
d) computer code for receiving an email addressed to the intermediary email address of the user via the network, the received email having a sender email address which identifies the email address of the sender;
e) computer code for comparing the sender email address with email addresses of the authorized parties associated with the user stored in the database; and
f) computer code for forwarding the received email via the network to the forwarding email address of the user if the sender email address is determined to match one of the email addresses of the authorized parties associated with the user stored in the database.
